(19) United States
(12) Patent Application Publication
(10) Pub. No.: US 2011/0307942 A1
(43) Pub. Date: Dec. 15, 2011

(54) Method and Apparatus for Authorization of Customer Premises Equipment

(76) Inventors: Michael Youssefmir, Portola Valley, CA (US); Philip R. Wiser, Nevada City, CA (US)

(21) Appl. No.: 13/118,084

(22) Filed: May 27, 2011

Related U.S. Application Data
(60) Provisional application No. 61/354,064, filed on Jun. 11, 2010.

(51) Int. Cl. H04L 9/32

(52) U.S. Cl. 726/4

(57) ABSTRACT

A computer-implemented method for requesting content over a public network is described. A customer premises equipment (CPE) can receive a time-varying signal over a private broadcast network. The signal can be used to generate authorization information on the CPE for content access over the public network. When a request for content that must be served over the public network is made at the CPE, the validity of the authorization information can be verified before the request is sent to the content delivery system.

### STATEMENT OF RELATED CASES

This application claims priority from provisional application 61/354,064, filed Jun. 11, 2010.

### BACKGROUND

1. Field

This disclosure is generally related to content delivery systems. More specifically, this disclosure is related to providing authorization of customer premises equipment to access content over a public network using a private network.

2. Related Art

A number of consumer electronics products and audiovisual media systems make use of varying types of digital rights management (DRM). The necessary keys to authorize playback can be in the sold item, e.g. DVD, or transmitted over the network used for content delivery, e.g. Apple iTunes delivery and authorization via the public internet; Windows DRM delivery and authorization via the public internet; and cable/satellite authorization and delivery via their private broadcast networks to customer premises equipments (CPEs).

### BRIEF DESCRIPTION OF THE FIGURES

FIG. 1 shows an architectural level schematic of a system in accordance with an embodiment.

FIG. 2 shows a flowchart illustrating the process of authorizing customer premises equipment over a private network for content access over a public network.

### DETAILED DESCRIPTION

### Overview

The discussion is organized as follows. First an introduction will be presented, followed by an explanation of terminology that will be used throughout the discussion. Then, a high-level description of one embodiment will be discussed at an architectural level. Then, details of algorithms used by embodiments are discussed. Lastly, various alternative embodiments are discussed.

Traditional systems that provide a wide array of linear content, especially live television and cable stations, together with nonlinear content require a significant amount of broadcast spectrum and/or infrastructure to the home. An approach using multiple networks to provide that breadth of content has been pioneered by Sezmi Corporation, see, e.g. U.S. patent application Ser. Nos. 12/082,954 (“Networked Antenna and Transport System Unit” filed 14 Apr. 2008), 12/082,955 (“Viewer Interface for a Content Delivery System” filed 14 Apr. 2008), 12/131,009 (“Programming Content Reconstruction in a Content Delivery System” filed 30 May 2008), and 12/290,583 (“Remote Control Unit for a Personalized Video Programming System” filed 31 Oct. 2008), and PCT application PCT/US2008/014014 (“System for Content Delivery” filed 23 Dec. 2008).

For example, if a customer's provider has only 20-30 Mbps of broadcast spectrum and is providing approximately 15 cable channels over that spectrum, as well as access to live over the air television content, how can the provider offer a deeper line-up of cable programming? Adaptive IP streaming of additional linear cable channels can increase the depth of the line-up for live viewing of linear content. Adaptive IP streaming is implemented via unicast transmission to an individual customer premises equipment (CPE) of the stream. But what steps can be taken to authorize the CPE to receive the adaptive IP stream over a public network such as the internet?

One option is for the customer's provider to attempt to secure on demand rights to that content. Such rights might permit sole use of a public network such as the internet for delivery with the use of suitable digital rights management (DRM) systems. Existing audiovisual rights agreements sometimes require linear content to be authorized via a private network. If the private network is not available for distribution, it can still be used for the authorization. We describe a system and various embodiments to authorize the CPE over the private (broadcast) network while using a public network, e.g. the internet, for content distribution.

### Terminology

Throughout this specification the following terms will be used:

Content: Content refers to a discrete piece of audiovisual programming. Some content is composed of multiple pieces of content. One example would be a single 30-minute situation comedy that is a piece of content that, when broadcast free over the air, generally includes commercials. The commercials are themselves content. The entirety of the broadcast is also considered a single piece of content. The intended meaning and scope of the term “content” should be apparent from the usage.

Provider: Provider refers to the entity, or entities, offering the content and related content delivery services to customers described by embodiments discussed herein. Providers may also offer programming. The provider could be an independent entity such as Sezmi Corporation, or a company more traditionally associated with providing linear content (e.g. cable and/or satellite programming) to customers such as a telephone company, an internet service provider (ISP), a cable company, or a satellite company.

Network: The term “network” has two distinct meanings in the context of this subject. The first meaning refers to the term given to broadcast, cable and/or satellite content originators, e.g. NBC network, Bravo network, etc. The second meaning refers to a technical computer network and the interconnection of devices via communications channels to permit communication between devices. Additional ambiguity can arise because individuals have small scale, or local area networks (LAN) inside their homes. And those networks are, in turn, coupled to the broader internet via an internet service provider (ISP). In general, the term “network” as used herein in the second sense will refer to the overall connection between the provider and the customer.

Two primary networks will be discussed, the first network being a network controlled and established by the provider. This network will generally be created by the provider acquiring rights to a portion of broadcast spectrum for private use (for example, the Sezmi Corporation contracting with the local San Francisco Bay Area NBC affiliate for 10 Mbps of broadcast spectrum). Note that to implement this network Sezmi may make use of additional transmission media such as satellite uplinks and downlinks to communicate with that affiliate and create the network to the customers. Similarly, WiMax, cellular, or other broadcast spectrum could be used to provide the first network. The second network that will be discussed is an open, public network such as the internet. The communications over the internet may be encrypted and/or tunneled; however, that does not alter the public nature of the network.

Linear Content: Linear content refers to content that an originator is transmitting to a customer such that (i) it can be received and viewed in real time; and (ii) it is not possible to jump arbitrarily forward past what the originator has transmitted up to that point in time. An example of linear content is live over the air television, e.g. watching the opening ceremony of the Olympics or 30 Rock live at the time of the original transmission. If the customer records linear content for later playback (“time shifting”), when it is played back later from the full recording, the content is then considered nonlinear content. Notwithstanding that, some trick play capabilities for linear content playback (pause live TV, back up, jump forward to current point of transmission) will not cause linear content to be considered nonlinear.

Nonlinear Content: Nonlinear content refers to content where the viewer can control the playback of the content and can jump to arbitrary points in the content. Examples of nonlinear content include: video on demand, podcasts, downloadable content, YouTube and similar online video sites, as well as playback of previously recorded linear content.

Broadcast and Broadcast Transmission: A broadcast transmission, or broadcasting, refers to wide-scale single point to multiple recipient distribution of content. A variety of transmission media can be used, e.g. television, cellular, satellite, as well as wired communications (e.g. cable or fiber.) The distinguishing characteristic of a broadcast, as opposed to a unicast, transmission is the one-to-many nature of the transmission.

Usage note: embodiments often make use of the spectrum of broadcasters, for example an NBC affiliate in the San Francisco Bay Area, for delivering content to viewers. As such, sometimes the terms “broadcast” or “broadcast transmission” can refer to the activities of those broadcasters. The meaning should be apparent from the context. For example, in the San Francisco Bay Area, a provider contracts with the local NBC broadcast affiliate for broadcast spectrum to deliver 10 MB of bandwidth. The provider then uses that 10 Mbps of bandwidth for the broadcast transmission of four high-definition cable channels as linear programming, e.g. Bravo, Lifetime, Food Network, and Syfy networks. Those networks are linear content sent as broadcast transmissions to the viewers.

Unicast or Unicast Transmission: A unicast transmission, or unicasting, refers to point to single point distribution of content. Typically, the transmission medium is a broadband, or high-speed, network connection. An example of a unicast transmission would be the delivery of a video on demand purchase to a single viewer over a high-speed network such as the internet. Some internet content delivery companies, e.g. Akamai, talk of offering “broadcast scale” transmissions; however, the offerings are, in fact, hundreds, or millions, of unicast transmissions.

Real Time: The term “real time” has two distinct meanings in the context of this subject. The first meaning refers to a minimal delay from an original transmission until the program can be received and viewed. For example, a range from milliseconds to a couple of minutes in some circumstances would still be considered real time. The acceptable waiting time will be described in the context of the usage. These delays occur because the original transmission must be received, processed, retransmitted, and received by the viewer's equipment and displayed. Continuing the earlier example from above of broadcasting the Bravo network over the local NBC broadcast affiliate's bandwidth, it may take a few seconds for the Bravo satellite signal to be received, transcoded, encrypted, and sent back out over that local NBC broadcast affiliate to a viewer's reception equipment. Some networks may include a short tape delay as part of a live broadcast, but this would still be considered a real time transmission.

The second meaning of “real time” refers to the suitability of a content stream for viewing relative to when a viewer initiates a request for playback of content and when the user can begin watching the content continuously. Depending on the context and viewer expectations, different periods of delay may be acceptable. The acceptable waiting time will be described in the context of the usage. Which of the two meanings is intended should be apparent from the context.

Non-real time: Non-real time refers to transmissions and viewing characteristics that do not meet the definition(s) of real time.

### System Overview

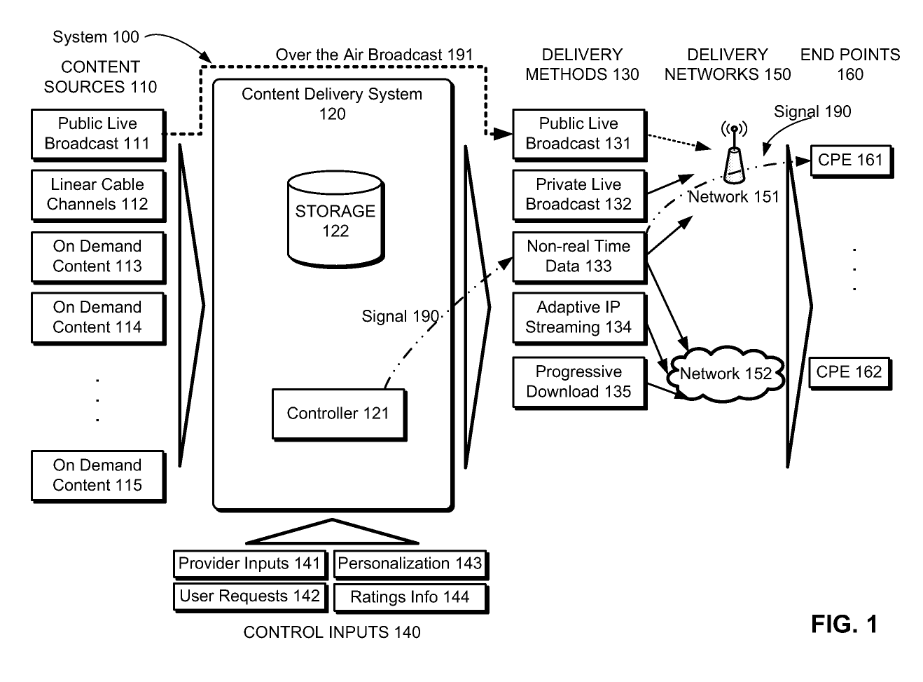

A system and processes described afford a way to improve authorization of CPEs using a private network for authorization to access content over a public network. The system will be described with reference to FIG. 1 showing an architectural level schematic of a system in accordance with an embodiment. Because FIG. 1 is an architectural diagram, certain details are intentionally omitted to improve the clarity of the description. The discussion of FIG. 1 will be organized as follows. First, the elements of the figure will be described, followed by their interconnections. Then, the use of the elements in the system will be described in greater detail.

FIG. 1 includes a system 100. The system includes content sources 110, a content delivery system 120, delivery methods 130, control inputs 140, delivery networks 150, and end points 160. The content sources 110 include public live broadcast 111, linear cable channels 112, and on demand content 113-115. The content delivery system 120 includes a controller 121 and a storage 122. The delivery methods 130 include public live broadcast 131, private live broadcast 132, non-real time data 133, adaptive IP streaming 134, and progressive download 135. Note that the difference between adaptive IP streaming 134 and progressive download 135 generally relates to the size of the buffer (progressive download 135 generally uses a larger buffer) and whether or not the approach requests different bit rates of the requested file in response to network conditions (adaptive IP streaming 134 will request different chunks of a piece of content at different bit rates in response to network conditions, while progressive download 135 will maintain a constant bit rate). The control inputs 140 include provider inputs 141, user requests 142, personalization 143, and ratings information 144. The delivery networks 150 include a network 151 and a network 152. In one embodiment, the network 151 is a broadcast network, e.g. transmission using a portion of the TV, cellular, Wi-Max, etc., spectrum. In some embodiments, the network 151 may use a wired medium such as a dedicated portion of a cable or fiber optic network. In one embodiment, the network 152 is a unicast network, e.g. transmission over the internet. The end points 160 have customer premises equipment (CPE) 161-162. Additionally a signal 190 transmitted from the content delivery system 120 to end points 160 is shown, which will be explained infra.

Throughout this discussion, the network 151 is a private network while the network 152 is a public network. As noted in most embodiments, the network 151 is a broadcast network over licensed spectrum procured by the provider of the system 100, although some embodiments might use dedicated channel capacity within a closed wired network such as a cable system, fiber optic network or the like. In many embodiments, the network 152 will be the public internet. Note that the use of encryption, SSL, SSH, tunnels, virtual private network (VPN) software, and the like do not change the “public” character of the network 152 for purposes of this discussion.

The interconnection of the elements of system 100 will now be described. The content sources 110 are coupled in communication to the content delivery system 120 (indicated by large triangle). The different sources may arrive via different mechanisms. For example, the public live broadcast 111 may be received using aerial antennas coupled to ATSC or other digital TV tuners. The linear cable channels 112 may be received via satellite downlink or over some other communications channel, e.g. encrypted content received over the internet. The content delivery system 120 may itself be geographically distributed, e.g. controller 121 and storage 122 are located in multiple places throughout the country or a region. For example, the public over-the-air broadcasts of San Francisco television stations must be received in the San Francisco area. However, the physical location of the primary network operations center of the content delivery system 120 may be in Florida. In this embodiment, cable feeds for linear cable channels 112 might be received via satellite downlink in Florida while local public live broadcasts in San Francisco may be received locally in San Francisco. More generally, the controller 121 may be a multitude of computer systems of a variety of types operating in conjunction and communication with one another to provide programming services to the end points 160. Similarly, the storage 122 may be a vast amount of data storage across a variety of systems and providers to store both on demand content 113-115 as well as user requested recordings.

Note also the dotted line representing the over the air broadcast 191 coupling the public live broadcast 111 to the public live broadcast 131 that bypasses the content delivery system 120 en route to end points 160 via network 151. This dotted line shows the standard over the air transmission, e.g. the local NBC affiliate in the San Francisco Bay Area reaching CPEs 161-162 if the customer can get good quality reception of that channel.

Continuing to describe the interconnections, the content delivery system 120 can make use of a number of delivery methods 130 to distribute content to end points 160. One delivery method is private live broadcast 132 which is transmitted over network 151. One example would be sending four cable networks in encrypted form over a portion of the local NBC affiliate's bandwidth in the San Francisco Bay Area. Another delivery method is non-real time data 133 which can be sent via either network 151 or network 152. The remaining delivery methods 130 can be adaptive IP streaming 134 and progressive download 135, both via network 152. The primary differences between the two were discussed, supra. The delivery networks 150 provide the communications channel to reach the end points 160 via their CPEs 161-162. Lastly, the content delivery system 120 receives a variety of control inputs 140. Some control inputs 140 come from the interactions of end points 160 with their CPEs 161-162. Others come from the operator of the content delivery system 120. The communications channels for those control inputs 140 are not shown in FIG. 1.

The signal 190 can be a communications signal including data that can be transmitted by the controller 121 from the content delivery system 120 as non-real time data 133. Because of the contractual obligations associated with the content, the signal 190 must be transmitted over a private network to end points 160 at their CPEs 161-162. In system 100, the private network is the network 151.

Having described the elements and their interconnections, the use of the system will be described in greater detail. The system 100 allows the provider operating the content delivery system 120 to offer a range of services to end points 160 via their CPEs 161-162. For example, users might purchase a package with the over the air channels in their area together with approximately 45 cable channels (linear cable channels 112). Some channels could be delivered via private live broadcast 132 over network 151 to the CPEs 161-162 using 20-30 Mbps of broadcast spectrum licensed from various providers such as TV, cellular, Wi-Max, etc. The remaining channels in the package can be delivered via adaptive IP streaming 134 over network 152 to the CPEs 161-162. One capability of the content delivery system 120 is to switch which of the linear cable channels 112 are provided to end points 160 via broadcast and which are provided via IP streaming at different times of the day, week, etc., based on the control inputs 140.

In some embodiments, the CPEs 161-162 include set top boxes, or other dedicated hardware, with the capability to receive programming over multiple networks simultaneously. The antennas for receiving the broadcast signals may be integrated or separate. In other embodiments, the CPEs 161-162 are computers with an antenna and tuner. In other embodiments, the antenna can be a network attached antenna. In still other embodiments, the CPE may be a hybrid “PBX-like” unit serving multiple dwellings in an apartment or residence with additional CPE equipment in each dwelling. We will focus on the CPE 162 which is a set top box with a network antenna that is operated by a remote control for the remainder of this example.

The provider of the content delivery system 120 faces different costs depending on which network is used. In general, the network 151 is created from licensed broadcast spectrum that is paid for once. There are minimal variable costs on network 151 depending on the amount of data transmitted. The network 151, also being broadcast in nature, permits greater distribution with a single transmission. In contrast, the network 152 may have low fixed costs but high variable costs based on the amount of data the content delivery system 120 transmits or needs to transmit in unicast fashion. For example, to permit 10,000 viewers to watch a linear showing of “Iron Chef America” over network 151, approximately 1.5 Mbps of total bandwidth is needed. In contrast to a broadcast transmission, an adaptive IP stream of “Iron Chef America” to the same number over end points over network 152, may have bandwidth requirements closer to 10,000×1.5 Mbps.

Accordingly, control inputs 140 are used by the content delivery system 120 and, in particular, by the controller 121 to determine which delivery methods 130 to use for which content. The provider inputs 141 can include the costs and maximum capacity of the different networks, the traffic load placed on the different networks, manual scheduling/routing decisions, and the like. Similarly, ratings information 144, e.g. Nielsen or Arbitron viewership information, can help optimize the use of the network 151. If more popular content is broadcast, then the amount of adaptive IP streaming 134 over network 152 can be reduced. Other inputs include personalization 143 and user requests 142. Conceptually, the personalization 143 includes information similar to the ratings information 144 but customized for the end points 160. Further, since the content delivery system 120 may be geographically distributed, the usage of the network 151 may be different in different regions. For example, if the San Francisco Bay Area loves “Iron Chef America,” the Food Network may be broadcast over network 151 there, while the Food Network may be adaptive IP streamed in another region based on actual viewership habits of the provider's customers. The user requests 142 are requests for specific content. These may be explicit requests such as “record all new episodes of Iron Chef America” or implicit requests created by the CPE 162. For example, the CPE 162 includes a personalization and recommendation system that may have determined that user #1 of the CPE is likely to want to watch “The Sopranos” and so it should be recorded. The CPE 162 can communicate the user requests 142 to the content delivery system 120. This can modify the use of the networks but also permit the content delivery system 120 to record the linear content to the storage 122 for later playback on the CPE 162.

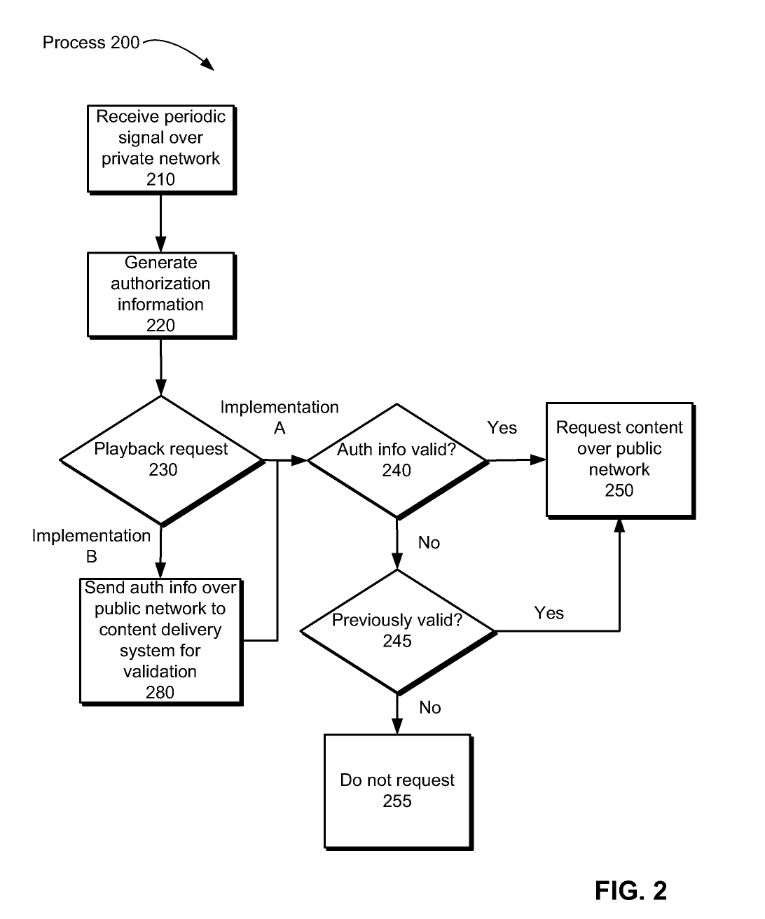

Returning to how the system 100 provides authorization to CPEs over a private network for access to content over a public network, consider a request from the CPE 161 for a linear cable channel, e.g. the Food Network, that will be delivered via adaptive IP streaming 134 over the network 152, a public network. For most of this discussion two primary embodiments will be considered: implementation A (CPE-based) and implementation B (content delivery system-based); see discussion of FIG. 2, infra. For now, implementation A will be considered. In this example, the CPE 161 must determine whether it has valid authorization information. The CPE 161 can do this if it has recently received the signal 190 over the network 151, a private network. The signal 190 is time-varying, e.g. it changes over time. The signal 190 is received and decoded, interpreted and/or decrypted by the CPEs 161-162. Only if the authorization information is current will the CPE 161 place a user request 142 for content to the content delivery system 120 for delivery over the network 152, a public network. Once the request is placed, the content is sent by the content delivery system 120 and the CPE 161 can begin playback. The details of this process will be discussed in greater detail, infra.

If the network 151 is implemented using licensed broadcast spectrum, the signal 190 will have an inherent geographic scope. For example, if the provider only offers services in the Los Angeles region, only those end points 160 with CPEs 161-162 physically proximate enough to the television station signals over which the network 151 is implemented can receive the signal 190. Further, in some embodiments, the signal itself can be source-verifiable, e.g. different in different regions. Thus the signal 190 sent at noon in the Los Angeles area may be different than the signal sent at noon in the Atlanta area.

The necessary bit rate of the transmission of the signal 190 is dependent on the maximum allowable delay in acquiring the validation messages. Given this, according to one embodiment, a reasonable period may be 250 ms, or four signals per second. This means that the CPE must wait a maximum of 500 ms to receive a valid signal 190 when it requires one. In order to transmit four signals per second, a bit rate of approximately 6 Kbps is required, see infra for an embodiment of the contents of the signal and the corresponding size. Note that, even if this embodiment is used, the contents of the signal may be regenerated less frequently than each transmission, e.g. new time-varying information once per second, once per hour, once per day, etc. The frequency with which the time-varying information is varied can be independent of the frequency with which the signal is transmitted. If less frequent validation by the CPE is required, even less bandwidth on the private network may be used.

Summarizing, the architecture of system 100 and the components and mechanism through which it provides authorization of CPEs using a private network for authorization to access content over a public network have been described.

### Processes

The process used by embodiments to provide authorization to CPEs over a private network for access to content over a public network will now be described with reference to FIG. 2. FIG. 2 shows a flowchart illustrating the process of authorizing customer premises equipment over a private network for content access over a public network. Two embodiments are shown and the embodiment of implementation A will be discussed first.

FIG. 2 includes a process 200 that starts with step 210 where the CPE receives a periodic signal over a private network. In the context of the system 100, the CPE 161 would need to periodically tune to the appropriate frequency to receive the broadcast of the signal 190 over the network 151. The signal 190 includes time-varying information (in other words, the contents of the signal are dependent on the time when the signal was first generated). The signal can be generated as often as multiple times a second, or less frequently, e.g. the same signal is used for an entire day. How often the signal 190 is sent and how often it is regenerated can depend on a variety of factors. For example, if at step 245 there is a relatively long period for gracefully handling a recent failure to receive authorization information, the signal might be transmitted less often.

On the other hand, if the signal is required for new customers to meaningfully start using CPEs, the signal might be transmitted more frequently. Thus, in one embodiment the signal is continuously transmitted. For example, if the signal 190 were only sent hourly, a new customer might face a 59-minute delay before their CPE was fully “active.” Further, given the possibility of reception problems and/or data transmission errors in over the air broadcasts, a higher frequency may be desirable. As calculated supra, as little as 6 Kbps of bandwidth would be required for nearly constant transmission of the signal 190 according to one format for the authorization information.

Next at step 220, the CPE generates the authorization information. In one embodiment, the signal includes information in the format described in ¶¶ [0048]-[0061], infra. In this embodiment, generating the authorization information includes extracting the nonce and signature from the signal 190. The verification of the signature using the public key of the content delivery system 120 can occur here, or later at step 240.

At step 230, a playback request is received at the CPE. This can be to tune to an adaptive IP stream 134 for one of the linear cable channels 112, or for access to on demand content 113-115, or for some other content. In some embodiments, the playback request at step 230 may be for content already locally stored on the CPE, e.g. previously recorded and/or downloaded content.

The process then continues at step 240 (implementation A) with the CPE determining whether or not the authorization information is valid. In one embodiment, this comprises validating the digital signature of the time-varying information included in the signal 190. As noted, the verification could have previously occurred at step 220. Also, if the signal included source-verifiable information corresponding to the geographic region, that can be verified at this step as well. If the signature confirms the time-varying information, the time-varying information is considered valid and/or the CPE considered authorized as of a given time. This means that content requests over the public network can proceed at step 250.

If the signature cannot be verified at step 240, or if no new time-varying information is available (for example, if the last time a signal was received at step 210 was several hours ago), the process can continue to step 245. Step 245 is an optional step; some embodiments require a quite recent signal, e.g. less than a few minutes old, while others permit a greater grace period. The provider can set the grace period which may be variable based on the type of content. For example, on demand content might have a different “time out” than adaptive IP streams. In another embodiment, if the content was requested at an earlier time, e.g. an order for a pay-per-view type event, and the CPE had valid authorization information at the time of the request, then the request may proceed to step 250.

Otherwise, the CPE does not make the request at step 255. The user of the CPE can be suitably notified of the lack of authorization information, for example by a message explaining that the CPE appears to be outside the broadcast range of the private network, etc. If source-verifiable information is included and the CPE is in the wrong geographic location, the user of the CPE may similarly be informed, e.g. “You are authorized to use this CPE in Los Angeles only; you are outside your home region,” etc.

As noted, process 200 also supports an implementation B. In implementation B, at step 220, generating the authorization information may include signing or encrypting the received authorization information with one or more private keys on the CPE. For example, a CPE-specific private key or a shared private key could be used. When the request is made at step 230, the process continues at step 280 with the authorization information (possibly signed) then sent to the content delivery system for validation. The content delivery system 120 then performs steps 240-255; the process is analogous to what was described for implementation A. In this embodiment, if the authorization information is required for playback of previously recorded content on the CPE, and the public network is unavailable for communicating with the content delivery system, the process may fall back to implementation A.

In either implementation A or B, the signal may contain one or more tokens. The use of tokens will be described with reference to implementation B. At step 220 in implementation B, the CPE may extract a token, e.g. “HBO token” from the signal. The extraction may make use of public-private key encryption, e.g. use the content delivery system's public key to decrypt the token and the CPE's private key to encrypt and/or sign the token before it is sent to the content delivery system for validation. In other embodiments, the token may be required by the digital rights management (DRM) system for decryption of a particular content stream. In still other embodiments, the CPE may include additional public and/or private keys for DRM and/or token access at step 220. For example, in one embodiment, the CPE may include a smart card, trusted platform module, or other device, programmed keys for certain content. In these embodiments only those CPEs which have the appropriate keys for HBO could decrypt the HBO token from the signal at step 220 to generate the authorization information.

### Sample Signal Contents

An example of the contents of the signal 190 according to one embodiment is described. In one embodiment, the authorization information is embedded in the signal as one or more MPEG-2 private sections. The use of the MPEG-2 encoding and format is specific to one embodiment. An explanation of MPEG-2 and private sections in MPEG-2 is outside the scope of this discussion. Likewise, an explanation of the cryptographic signature and techniques used is similarly outside the scope of this discussion.

In this embodiment, the format of the authorization information is as follows:

| Field Name/Syntax | No. Bits | Mnemonic |
|---|---|---|
| authorizarization_section ( ) { | | |
| table_id | 8 | 0xFD |
| section_syntax_indicator | 1 | ‘1’ |
| private_indicator | 1 | ‘0’ |
| Reserved | 2 | ‘11’ |
| section_length | 12 | uimsbf |
| table_id_extension | 16 | 0x0000 |
| Reserved | 2 | ‘11’ |
| version_number | 5 | 0x01 |
| current_next_indicator | 1 | ‘1’ |
| section_number | 8 | 0x00 |
| last_section_number | 8 | 0x00 |
| Nonce | 256 | |
| Signature | 384 | |
| CRC_32 | 32 | rpchof |
| } | | |

The fields are defined and defaulted as follows according to one embodiment:

table-id: An 8-bit field, set to 0xFD.

section_syntax_indicator: A 1-bit indicator set to ‘1’, indicating that the section complies with the generic section syntax defined in ISO/IEC 13818-1, clause 2.4.4.11.

private_indicator: A 1-bit flag set to ‘0’.

section_length: This 12-bit field shall be set as defined by ISO/IEC 13818-1, clause 2.4.4.11.

table_id_extension: A 16-bit value, set to 0x0000.

version_number: A 5-bit field conveying the version of the protocol used by this section, set to 0x01 for this version.

current_next_indicator: A 1-bit field, set to ‘1’, indicating that the section is currently applicable.

section_number: An 8-bit field, set to 0x00.

last_section_number: An 8-bit field, set to 0x00.

nonce: A 256-bit (32-byte) unique pseudorandom value, meaning that the output should be hard to guess, but need not be cryptographically secure. The nonce, therefore, includes a time component, and ensures the time-varying nature of the signal 190. In one embodiment, the nonce is the result of the bit-wise exclusive-OR (XOR) of a 16-byte time value and a 32-byte pseudorandom number, where the time value comprises the current time in seconds since an epoch (8 bytes) concatenated with the current time since the epoch in nanoseconds (8 bytes).

signature: A DSS1 signature of the nonce is generated using the provider's private key (e.g. a key known by the content delivery system 120 but not the CPEs 161-162) and encoded using ASN.1 Distinguished Encoding Rules (DER). The combination of DSA with SHA-1 is sometimes referred to as “DSS1.” The CPEs 161-162 can use the provider's public key to verify the DSS1 signature. The signature can be calculated using the DSA Signature Generation algorithm in FIPS 186-3, section 4.6. The SHA-256 hash algorithm is the preferred algorithm, but for compatibility with software libraries, the SHA-1 algorithm may also be used.

CRC_{—}32: This field is used and set as specified in ISO/IEC 13818-1, clause 2.4.4.11.

Additionally, the signal may include one or more tokens. The tokens can be additional data in a predetermined format for use in validating or authorization access to specific content, specific channels, etc. The tokens may themselves be encrypted data, which when decrypted provide keys for decrypting the corresponding content.

Other data formats can be used to encode and/or packetize the contents of the signal. In the above format, the time-varying nonce field and the signature field used to verify the nonce are highly relevant for providing a time-varying signal for use in authorization of CPEs. The other fields conform to providing and encoding the signal into an MPEG-2 transport stream. If other encodings are used, the fields and format can be suitably modified and/or transmitted separately from the transport stream containing content.

### Conclusion and Alternative Embodiments

We have now described a system and processes that improve authorization of CPEs using a private network for authorization to access content over a public network.

Some embodiments use multiple signals for different types of content and/or different content. For example, there might be one signal for playback of local content, one for adaptive IP streaming, and another for on demand content. Each of these signals might, in turn, be signed by different private keys. Further, in some embodiments different content requires different validations, with some content requiring public network based validation (implementation B), while other content only requires CPE based validation (implementation A).

Some embodiments periodically check for an up-to-date authorization information during the playback of content. More specifically, the steps of process 200 may continue after play commences at step 250. For example, in some embodiments, the presence of valid authorization information may be tested once every X minutes (or seconds) during playback. In some embodiments, the frequency of the checking is determined based on the content requested. For example, some types of content may require more frequent validation of the authorization information than other content. If the authorization information is too old, the playback can be stopped, degraded, etc. For example, if the authorization information must validated at least once per minute, than after 2 minutes, the playback might be degraded (lower bit rate encoding, lower resolution display of the content, etc.). Similarly, after a longer period the playback might be halted, e.g. 5 or 15 minutes. The times given are exemplary only and longer or shorter periods might be used.

Embodiments may incorporate programmability on the CPEs to permit upgrades to the generation (step 220) and authorization (step 240) processes to deal with attempts to circumvent the authorization process. For one, the private-public key pair used can be periodically updated. But additional programmability can enable the system as a whole to handle more sophisticated attacks.

In still other embodiments, the authorization information generated from the signal may be used to retrieve, unlock, and/or otherwise determine one or more digital rights management (DRM) keys for decrypting and/or authorizing playback of the content at the CPE. In such an embodiment, the playback can be said to be dependent on the authorization information. As discussed, supra, this may include the inclusion of one or more tokens in the signal.

Some embodiments may use some or all of the following features:

per CPE key—the time-varying signal is signed separately and differently for each CPE with a unique digital key for that CPE thus authorizing content requests separately for each CPE.

per broadcast tower keys—the time-varying signal is signed differently for different broadcast transmission points in network 151. This may be useful for providing greater geographical control over which CPEs can access which content.

Any data structures and code described or referenced, supra, are stored according to many embodiments on a computer-readable storage medium, which may be any device or medium that can store code and/or data for use by a computer system. This includes, but is not limited to, volatile memory, non-volatile memory, application-specific integrated circuits (ASICs), field-programmable gate arrays (FPGAs), magnetic and optical storage devices such as disk drives, magnetic tape, CDs (compact discs), DVDs (digital versatile discs or digital video discs), or other media capable of storing computer-readable media now known or later developed.

The preceding description is presented to enable the making and use of the invention. Various modifications to the disclosed embodiments will be apparent, and the general principles defined herein may be applied to other embodiments and applications without departing from the spirit and scope of the invention. Thus, the invention is not intended to be limited to the embodiments shown, but is to be accorded the widest scope consistent with the principles and features disclosed herein. The scope of the invention is defined by the appended claims.

What is claimed is:

1. A computer-implemented method of requesting content over a public network, comprising:
receiving a signal on a customer premises equipment (CPE) from a private broadcast network, the signal generated by a content delivery system, the signal including a time-varying information;
generating at the CPE an authorization information, the authorization information based on the time-varying information from the signal;
receiving a request for a content at the CPE, the request corresponding to a request for delivery via the public network of the content from the content delivery system; and
determining whether the CPE is in an authorized state using the authorization information, and if the CPE is in the authorized state, placing a request over the public network to the content delivery system for the content.

2. The computer-implemented method of claim 1, wherein the determining further comprises:
transmitting the authorization information to the content delivery system over the public network and receiving a second signal over the public network from the content delivery system indicating the authorized state of the CPE.

3. The computer-implemented method of claim 1, further comprising:
playing the content received over the public network from the content delivery system using the CPE, the playing dependent on the authorization information.

4. The computer-implemented method of claim 1, wherein the signal further includes a source-verifiable information corresponding to a geographic region.

5. The computer-implemented method of claim 1, further comprising:
changing the CPE to the authorized state if the CPE was in the authorized state within a predetermined period of time despite the authorization information being at least one of not available and not valid.

6. A computer-implemented method of requesting content over a public network, comprising:
transmitting a signal from a content delivery system to a plurality of customer premises equipments (CPEs) over a private broadcast network, the signal including a time-varying information;
receiving a request from a CPE in the plurality of CPEs over the public network, the request identifying a content from the content delivery system and an authorization information, the authorization information dependent on the time-varying information in the signal; and
transmitting the content over the public network to the CPE from the content delivery system after the content delivery system confirms a validity of the authorization information.

7. The computer-implemented method of claim 6, wherein the signal further includes a source-verifiable information corresponding to a geographic region and wherein the authorization information is dependent on the source-verifiable information.

8. The computer-implemented method of claim 6, wherein the content is at least partially encrypted using the authorization information.

9. The computer-implemented method of claim 6, further comprising: the CPE playing the content subsequent to the transmitting, the playing dependent on the authorization information.

10. A computer-implemented method of playing back content previously received over a public network, comprising:
receiving a signal on a customer premises equipment (CPE) from a private broadcast network, the signal generated by a content delivery system, the signal including a time-varying information;
generating at the CPE an authorization information, the authorization information based on the time-varying information from the signal;
responsive to a request to play back a locally stored content on the CPE, determining whether the CPE is in an authorized state using the authorization information; and
if the CPE is in the authorized state, playing back the locally stored content.

11. The computer-implemented method of claim 10, wherein the determining further comprises:
transmitting the authorization information to the content delivery system over the public network and receiving a second signal over the public network from the content delivery system indicating the authorized state of the CPE.

12. The computer-implemented method of claim 10, wherein the playing is dependent on the authorization information.

13. The computer-implemented method of claim 10, wherein the signal further includes a source-verifiable information corresponding to a geographic region.

14. The computer-implemented method of claim 10, further comprising:
changing the CPE to the authorized state if the CPE was in the authorized state within a predetermined period of time despite the authorization information being at least one of not available and not valid.

15. A system for playback of audiovisual content, comprising:
a user input interface;
a first network interface to a first network comprising a private broadcast network;
a second network interface to a second network comprising a public network; and
a computer system, the computer system coupled in communication with the user input interface and the first network interface and the second network interface, the computer system to
receive a signal over the first network interface, the signal generated by a content delivery system, the signal including a time-varying information;
generate an authorization information based on the time-varying information from the signal;
receive over the user input interface a request for a content, the content for delivery from the content delivery system via the second network interface; and
determine whether the CPE is in an authorized state using the authorization information, and if the CPE is in the authorized state, placing a request over the second network interface to the content delivery system for the content.

16. The system of claim 15, wherein the user input interface is a remote control, the first network interface is a tuner coupled to an antenna for broadcast reception, and the second network interface is at least one of an Ethernet interface and a WiFi interface.

17. The system of claim 15, further comprising a local storage coupled in communication with the computer system, the computer system further storing the content on the local storage for playback at a later time.

18. The system of claim 15, wherein the determining further comprises:
transmitting the authorization information to the content delivery system over the second network interface and receiving a second signal over the second network interface from the content delivery system indicating the authorized state of the system.
